(19) United States
(12) Patent Application Publication
(10) Pub. No.: US 2026/0358748 A1
(43) Pub. Date: Nov. 12, 2026

(54) OPERATION DEVICE AND IMAGE FORMING APPARATUS

(71) Applicants: Mitsuki SATO, KANAGAWA (JP); Masateru UJIIE, KANAGAWA (JP)

(72) Inventors: Mitsuki SATO, KANAGAWA (JP); Masateru UJIIE, KANAGAWA (JP)

(73) Assignee: Ricoh Company, Ltd., Tokyo (JP)

(21) Appl. No.: 19/673,019

(22) Filed: May 11, 2026

(30) Foreign Application Priority Data
May 12, 2025 (JP) 2025-079930

(51) Int. Cl. G03G 21/16; G03G 15/00

(52) U.S. Cl. CPC G03G 21/1647; G03G 15/5016; G03G 21/1619

(57) ABSTRACT

An operation device provided for an apparatus body of an apparatus, includes: an operation panel including a data-transmission-unit connecting portion at a rear surface of the operation panel, the data-transmission-unit connecting portion to which a data transmission unit connected from the apparatus body is connected; a first fixing member located on the rear surface of the operation panel and having a first opening from which the data-transmission-unit connecting portion is exposed; and a second fixing member fixable at a first position and a second position with respect to a rear surface of the first fixing member, the second fixing member exposing the data-transmission-unit connecting portion at the first position or the second position.

### CROSS-REFERENCE TO RELATED APPLICATIONS

This patent application is based on and claims priority pursuant to 35 U.S.C. § 119(a) to Japanese Patent Application No. 2025-079930, filed on May 12, 2025, in the Japan Patent Office, the entire disclosure of which is hereby incorporated by reference herein.

### BACKGROUND

### Technical Field

The present disclosure relates to an operation device and an image forming apparatus.

### Related Art

Apparatuses such as image forming apparatuses include an operation device including an operation panel to be operated by a user and a member that fixes the operation panel. The operation panel is attached to the apparatus body via a fixing member. A data transmission unit such as a cable for data communication with the apparatus body is connected to the operation panel.

For example, an image forming apparatus is disclosed that includes a housing-side attachment portion on a housing, a panel-side attachment portion on an operation panel, a rotation shaft that rotates the housing-side attachment portion, and an insertion fixture that is inserted into a housing-side insertion hole in the housing-side attachment portion and a panel-side insertion hole in the panel-side attachment portion to fix the housing-side attachment portion and the panel-side attachment portion to each other.

### SUMMARY

The present disclosure described herein provides an operation device provided for an apparatus body of an apparatus. The operation device includes an operation panel including a data-transmission-unit connecting portion at a rear surface of the operation panel, the data-transmission-unit connecting portion to which a data transmission unit connected from the apparatus body is connected; a first fixing member located on the rear surface of the operation panel and having a first opening from which the data-transmission-unit connecting portion is exposed; and a second fixing member fixable at a first position and a second position with respect to a rear surface of the first fixing member. The second fixing member exposes the data-transmission-unit connecting portion at the first position or the second position.

The present disclosure described herein provides an image forming apparatus including the above-described operation device; and the apparatus body including an image forming device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view illustrating an example of an overall configuration of an image forming apparatus;

FIG. 2 is a perspective view illustrating an example of a fixed state of an operation device at a first position;

FIG. 3 is a rear view illustrating an example of a fixed state of an operation device at a first position;

FIG. 4 is a perspective view illustrating an example of a fixed state of a first fixing member and a second fixing member at a first position;

FIG. 5 is a configuration diagram illustrating an example of a fixed state of a first fixing member and a second fixing member at a first position;

FIG. 6 is a rear view illustrating an example of a fixed state of an operation device at a second position;

FIG. 7 is a perspective view illustrating an example of a fixed state of a first fixing member and a second fixing member at a second position;

FIG. 8 is a configuration diagram illustrating an example of a fixed state of a first fixing member and a second fixing member at a second position;

FIG. 9 is a partially enlarged view of the vicinity of an auxiliary protrusion and a second protrusion in FIG. 7;

FIG. 10 is a configuration diagram illustrating another example of a fixed state of a first fixing member and a second fixing member at a first position; and

FIG. 11 is a configuration diagram illustrating another example of a fixed state of a first fixing member and a second fixing member at a second position.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The embodiments described below are not intended to limit the present disclosure to the embodiments described below.

The dimensions, materials, shapes, and relative configurations of the components described below are intended to be illustrative and not limiting of the scope of the disclosure, unless otherwise specified. For example, the size and positional relationship of components illustrated in the drawings may be exaggerated for clarity of description. In the present specification, image formation and recording are synonyms.

### Image Forming Apparatus

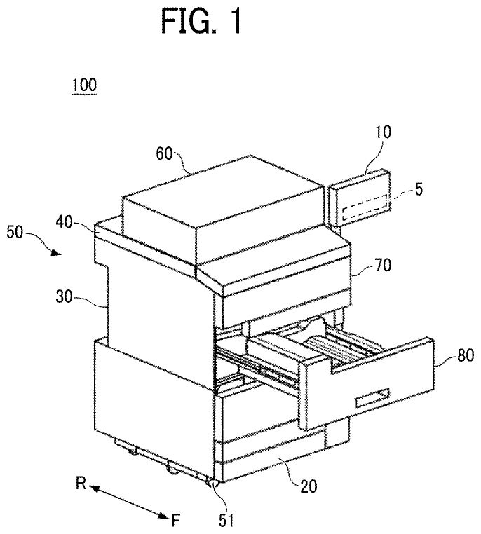

FIG. 1 is a perspective view illustrating an overall configuration of an image forming apparatus 100. In FIG. 1, reference sign F denotes a direction on the front surface side of the image forming apparatus 100, and reference sign R denotes a direction on the rear surface side of the image forming apparatus 100.

As illustrated in FIG. 1, the image forming apparatus 100 includes an operation device 10. The image forming apparatus 100 is a digital multifunction peripheral including an apparatus body 50 including a sheet feeder 20, an image forming device 30, and an image reading device 40; an automatic document feeder (ADF) 60 located on the apparatus body 50; and the operation device 10 provided for the apparatus body 50.

The image forming device 30 includes a toner supply 70 including a front door, and a drawer 80 on the front surface side F. The apparatus body 50 includes multiple casters 51 on the bottom surface of the apparatus body 50 for easier movement of the image forming apparatus 100.

The sheet feeder 20 includes multiple stages of sheet feeding cassettes that can store cut-sheet-shaped transfer sheets in a stacked manner. The sheet feeder 20 includes a sheet feeding device and various rollers that sequentially pick up, separate, and feed the transfer sheets stored in each sheet feeding cassette from the top of the transfer sheets. The transfer sheet fed from each sheet feeding device is conveyed to a predetermined image formation position of the image forming device 30.

The image forming device 30 includes, for example, exposure devices, photoconductor drums, and developing devices filled with toners of black (K), yellow (Y), magenta (M), and cyan (C), and performs image formation. The image forming device 30 includes a primary transfer portion, a secondary transfer portion, and a fixing portion.

The image forming device 30 primarily transfers toner images developed on the photoconductor drums to the primary transfer portion, and secondarily transfers the toner images to a transfer sheet at the secondary transfer portion located near the primary transfer portion. The image forming device 30 heats and presses the toner images secondarily transferred to the transfer sheet using the fixing portion to melt the toner images to fix and record a color image on the transfer sheet. The transfer sheet passes through the secondary transfer portion and the fixing portion in synchronization with the belt speed at the primary transfer portion and the secondary transfer portion, and then is ejected onto a sheet ejection tray.

The automatic document feeder 60 is coupled to an upper portion of the apparatus body 50 via a hinge mechanism so as to be openable and closable. The automatic document feeder 60 is implemented by a sheet-through automatic document feeder. The automatic document feeder 60 includes, for example, a document table as an example of a media tray, a document conveyance portion including various rollers and a guide member, and a document ejection tray on which document sheets after image reading are stacked.

### Operation Device

The position of a connecting portion for a data transmission unit such as a cable included in an operation panel may vary depending on the model of the operation panel. A connecting portion for a data transmission unit and a fixing member of an operation panel overlap each other depending on the model of the operation panel in an operation device of related art, which is inconvenient for the work of connecting the data transmission unit.

In view of the situation, the operation device 10 according to an embodiment of the present disclosure can change the position at which the operation device 10 is fixed.

More specifically, the operation device 10 is fixed at one of a first position and a second position.

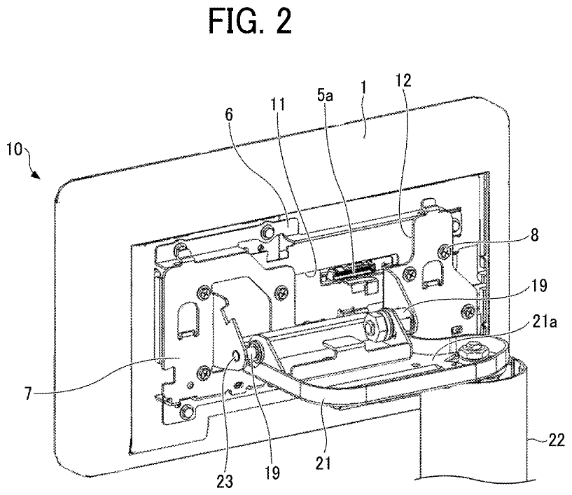

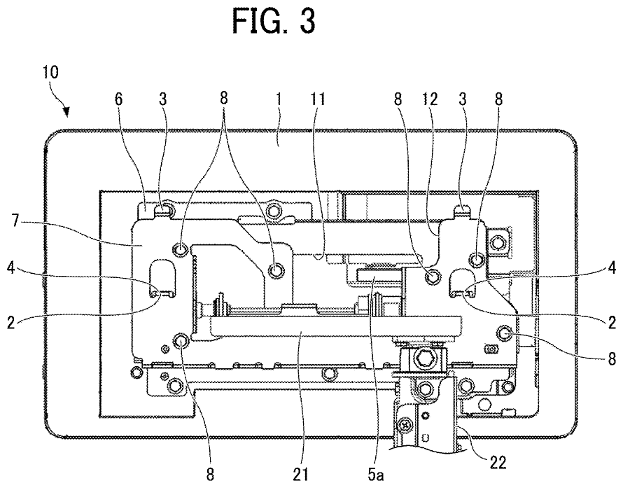

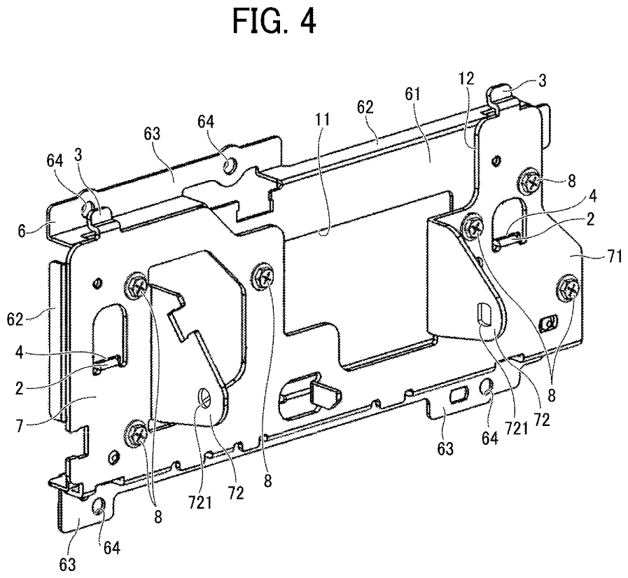

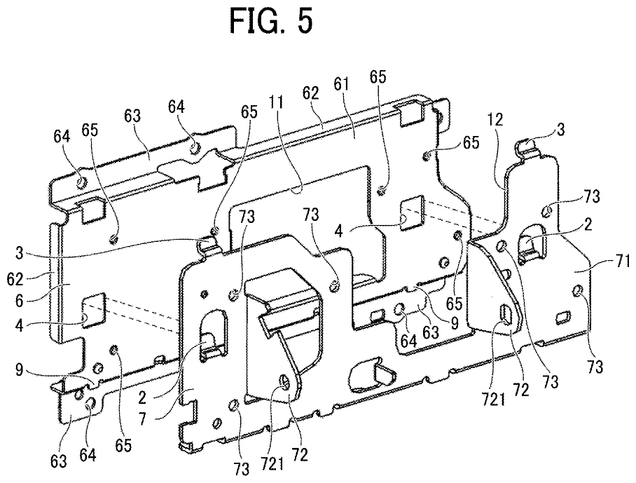

FIG. 2 is a perspective view illustrating a fixed state of the operation device 10 at the first position. FIG. 3 is a rear view illustrating the fixed state of the operation device 10 at the first position. FIG. 4 is a perspective view illustrating a fixed state of a first fixing member 6 and a second fixing member 7 at the first position. FIG. 5 is a configuration diagram illustrating the fixed state of the first fixing member 6 and the second fixing member 7 at the first position. FIGS. 4 and 5 illustrate the first fixing member 6 and the second fixing member 7 with an operation panel 1 and a coupling member 21, which will be described later, removed.

In the present specification, the fixed state at the first position means a state where the first fixing member is fixed to the second fixing member at the first position. The fixed state at the second position means a state where the first fixing member is fixed to the second fixing member at the second position. A surface of the first fixing member 6 facing the operation panel 1 in the thickness direction is referred to as a front surface, and a surface opposite to the front surface is referred to as a rear surface. A surface of the second fixing member 7 facing the operation panel 1 in the thickness direction is referred to as a front surface, and a surface opposite to the front surface is referred to as a rear surface. An upper side and a lower side in the up-down direction of the operation panel 1 are referred to as an upper side and a lower side, respectively.

While the operation device 10 is provided for the apparatus body 50 of the image forming apparatus 100 in the present embodiment, the operation device 10 may be provided for any apparatus body without being limited to the image forming apparatus 100.

As illustrated in FIGS. 2 and 3, the operation device 10 includes the operation panel 1, the first fixing member 6, and the second fixing member 7. The operation device 10 includes a fastening member 8 such as a screw that fastens the first fixing member 6 and the second fixing member 7 to each other in the state where the first fixing member 6 is fixed to the second fixing member 7 at the first position or in the state where the first fixing member 6 is fixed to the second fixing member 7 at the second position. The operation device 10 includes a support member 22 and a coupling member 21. The support member 22 is located on a side surface of the apparatus body 50 and extends in a direction orthogonal to the bottom surface of the apparatus body 50. The coupling member 21 couples the second fixing member 7 and the support member 22 to each other.

The operation panel 1 includes a liquid crystal display including a touch sensor. The operation panel 1 receives various inputs corresponding to operations of a user using the liquid crystal display, and displays, for example, various items of data such as data corresponding to the received input, data indicating the operation status of the image forming apparatus 100, and data indicating settings.

The operation panel 1 includes a controller 5 (FIG. 1) that controls the operation panel 1. The operation panel 1 includes a data-transmission-unit connecting portion 5a that is located at the rear surface, which is the surface opposite to the operation screen, and to which a data transmission unit such as a cable connected from the apparatus body 50 is connected. When the data transmission unit is connected to the data-transmission-unit connecting portion 5a, the operation panel 1 and the apparatus body 50 can perform data communication, and the controller 5 transmits or receives signals via the data transmission unit.

The first fixing member 6 is located on the rear surface of the operation panel 1. As illustrated in FIGS. 4 and 5, the first fixing member 6 has a flat plate portion 61, a peripheral wall portion 62, and a panel attachment portion 63. The peripheral wall portion 62 extends perpendicularly to the flat plate portion 61 from a peripheral edge of the flat plate portion 61. The panel attachment portion 63 extends perpendicularly to the peripheral wall portion 62 from an end portion of the peripheral wall portion 62.

The flat plate portion 61 may have a fastening hole 65 to which the fastening member 8 is fastened. The peripheral wall portion 62 may extend over the entire peripheral edge of the flat plate portion 61, or may partially extend on the peripheral edge of the flat plate portion 61, in other words, intermittently extend on the peripheral edge. The panel attachment portion 63 may extend over the entire end portion of the peripheral wall portion 62 or may partially extend on the end portion of the peripheral wall portion 62. The panel attachment portion 63 may have a fastening hole 64 into which a fastening member such as a screw is inserted.

With the panel attachment portion 63 attached to the rear surface of the operation panel 1 with the fastening member 8, the flat plate portion 61 and the rear surface of the operation panel 1 are separated from each other via the peripheral wall portion 62. In other words, a space is formed between the first fixing member 6 and the rear surface of the operation panel 1.

The first fixing member 6 has an engagement hole 4. Specifically, the engagement hole 4 extends through the flat plate portion 61. The engagement hole 4 and the rear surface of the operation panel 1 are separated from each other. A first protrusion 2 or a second protrusion 3, which will be described later, of the second fixing member 7 is engageable with the engagement hole 4.

The engagement hole 4 may include two engagement holes 4. The two engagement holes 4 may be located in line symmetry with respect to a vertical line including the center of gravity of the operation panel 1. The two engagement holes 4 may have the same height from the lower end of the operation panel 1. However, the location of the two engagement holes 4 is not limited thereto. For example, the engagement holes 4 may be located at positions corresponding to a right portion and a left portion of the operation panel 1 with respect to the center of gravity of the operation panel 1. In this case, the engagement holes 4 may be asymmetrically located with respect to the center of gravity of the operation panel 1. The engagement hole 4 may include two or more engagement holes 4.

The first fixing member 6 has a first opening 11 from which the data-transmission-unit connecting portion 5a is exposed. Specifically, the first fixing member 6 has the first opening 11 at a position overlapping the data-transmission-unit connecting portion 5a when viewed in the direction orthogonal to the flat plate portion 61. The first opening 11 extends through the flat plate portion 61 of the first fixing member 6.

With the first fixing member 6 attached to the rear surface of the operation panel 1, the data-transmission-unit connecting portion 5a is entirely exposed from the first opening 11. The first opening 11 may be a closed-off opening, and the shape of the first opening 11 may be substantially quadrangular when viewed in the direction orthogonal to the flat plate portion 61.

The second fixing member 7 detachably fixes the first fixing member 6. The second fixing member 7 can be fixed to the rear surface of the first fixing member 6 at the first position and the second position.

As illustrated in FIGS. 4 and 5, the second fixing member 7 may include a flat plate portion 71 and a coupling-member attachment portion 72 extending perpendicularly from the rear surface, which is the surface opposite to the surface facing the first fixing member 6, of the flat plate portion 71. The flat plate portion 71 may have a fastening hole 73 to which the fastening member 8 is fastened.

The coupling member 21 is attached to the coupling-member attachment portion 72. The coupling-member attachment portion 72 may have a hole 721 through which a rotation shaft 23, which will be described later, is inserted.

The coupling-member attachment portion 72 may include two coupling-member attachment portions 72. The two coupling-member attachment portions 72 may be located in line symmetry with respect to a vertical line including the center of gravity of the operation panel 1. However, the location of the coupling-member attachment portions 72 is not limited thereto. For example, the coupling-member attachment portions 72 may be located at positions corresponding to the right portion and the left portion of the operation panel 1 with respect to the center of gravity of the operation panel 1. In this case, the coupling-member attachment portions 72 may be asymmetrically located with respect to the center of gravity of the operation panel 1.

The second fixing member 7 has the first protrusion 2 engageable with the engagement hole 4 and the second protrusion 3 engageable with the engagement hole 4. Specifically, the first protrusion 2 and the second protrusion 3 are located at the flat plate portion 71. The second fixing member 7 fixes the first fixing member 6 at the first position when the first protrusion 2 engages with the engagement hole 4. The second fixing member 7 fixes the first fixing member 6 at the second position when the second protrusion 3 engages with the engagement hole 4.

The first protrusion 2 may include two first protrusions 2. The second protrusion 3 may include two second protrusions 3. The two first protrusions 2 may have the same height from the lower end of the second fixing member 7. The two second protrusions 3 may have the same height from the lower end of the second fixing member 7, and the height of the two second protrusions 3 may be different from the height of the two first protrusions 2. The two first protrusions 2 may have the same height in the vertical direction with respect to the operation panel 1. The two second protrusions 3 may have the same height in the vertical direction with respect to the operation panel 1, and the height of the two second protrusions 3 in the vertical direction with respect to the operation panel 1 may be different from the height of the two first protrusions 2 in the vertical direction with respect to the operation panel 1. In the present specification, the height from the lower end of the second fixing member 7 means the smallest distance from the end edge located at the lowermost position of the second fixing member 7.

Specifically, the height of the second protrusions 3 from the lower end of the second fixing member 7 may be larger than the height of the first protrusions 2 from the lower end of the second fixing member 7. In the example illustrated in FIGS. 2 to 5, the second protrusions 3 are located at an upper end portion of the second fixing member 7. In other words, the second protrusions 3 are located at an upper end portion of the flat plate portion 71.

The two first protrusions 2 may be located in line symmetry with respect to a vertical line including the center of gravity of the operation panel 1. The two second protrusions 3 may be located in line symmetry with respect to the vertical line including the center of gravity of the operation panel 1. However, the location of the two first protrusions 2 and the two second protrusions 3 is not limited thereto. For example, the two first protrusions 2 or the two second protrusions 3 may be located at positions corresponding to the right portion and the left portion of the operation panel 1 with respect to the center of gravity of the operation panel 1. In this case, the two first protrusions 2 or the two second protrusions 3 may be asymmetrically located with respect to the center of gravity of the operation panel 1. The first protrusion 2 may include two or more first protrusions 2. The second protrusion 3 may include two or more second protrusions 3.

The first protrusion 2 and the second protrusion 3 may each have a hook shape protruding toward the first fixing member 6 and having a tip portion extending upward. The first protrusion 2 and the engagement hole 4 engage with each other as illustrated in FIG. 4 when the first fixing member 6 is moved from the upper end side toward the lower end side of the second fixing member 7 with the rear surface of the first fixing member 6 facing the front surface of the second fixing member 7 as illustrated in FIG. 5. Specifically, the user can fix the operation panel 1 to the second fixing member 7 when the user holds both ends of the operation panel 1 and moves the first fixing member 6 from the upper end side toward the lower end side of the second fixing member 7 with the rear surface of the first fixing member 6 facing the front surface of the second fixing member 7.

The second fixing member 7 may have a second opening (cutout) 12. The second opening 12 may extend through the flat plate portion 71 of the second fixing member 7. The second opening 12 is formed at the upper end of the flat plate portion 71 and opens upward of the flat plate portion 71. When viewed in the direction orthogonal to the flat plate portion 71, the shape of the second opening 12 may be a trapezoid having a shorter base near the lower end of the second fixing member 7 and a step portion on a leg. The shape of the second opening 12 is not limited thereto, and may be, for example, another rectangular shape or a semicircular shape.

With the first fixing member 6 fixed to the second fixing member 7 at the first position as illustrated in FIG. 4, contact surfaces of the first fixing member 6 and the second fixing member 7 may be smooth surfaces.

The first position is a position at which the first fixing member 6 and the second fixing member 7 can be fixed to each other with the fastening member 8. The second position is a position at which the first fixing member 6 and the second fixing member 7 cannot be fixed to each other with the fastening member 8 but are just held. In this case, a contact area between the first fixing member 6 and the second fixing member 7 with the first fixing member 6 fixed to the second fixing member 7 at the first position may be larger than a contact area between the first fixing member 6 and the second fixing member 7 with the first fixing member 6 fixed to the second fixing member 7 at the second position, which will be described later. However, by changing the positions of the fastening hole 65 and the fastening hole 73, the second position may be set to a position at which the first fixing member 6 and the second fixing member 7 can be fixed to each other with the fastening member 8, and the first position may be set to a position at which the first fixing member 6 and the second fixing member 7 cannot be fixed to each other with the fastening member 8 but are just held. In this case, a contact area between the first fixing member 6 and the second fixing member 7 with the first fixing member 6 fixed to the second fixing member 7 at the second position may be larger than a contact area between the first fixing member 6 and the second fixing member 7 with the first fixing member 6 fixed to the second fixing member 7 at the first position.

The coupling member 21 may be attached to the coupling-member attachment portion 72 of the second fixing member 7 via a rotation mechanism 19. The coupling member 21 has an insertion hole through which a rotation shaft 23 is inserted. In other words, the operation device 10 may include the rotation shaft 23 that rotatably supports the second fixing member 7.

While the rotation shaft 23 rotatably supports the second fixing member 7 in the present embodiment, the rotation shaft 23 may rotatably support the first fixing member 6. In this case, the second fixing member 7 does not have the coupling-member attachment portion 72, but the first fixing member 6 has a coupling-member attachment portion.

The coupling member 21 may have a flat plate portion 21a extending horizontally, and may be attached to the support member 22 such that the flat plate portion 21a is orthogonal to the support member 22.

With the above-described configuration, when the first fixing member 6 is fixed at the first position as illustrated in FIGS. 2 to 5, the data-transmission-unit connecting portion 5a exposed from the first opening 11 of the first fixing member 6 is partially or entirely covered with the flat plate portion 71 of the second fixing member 7.

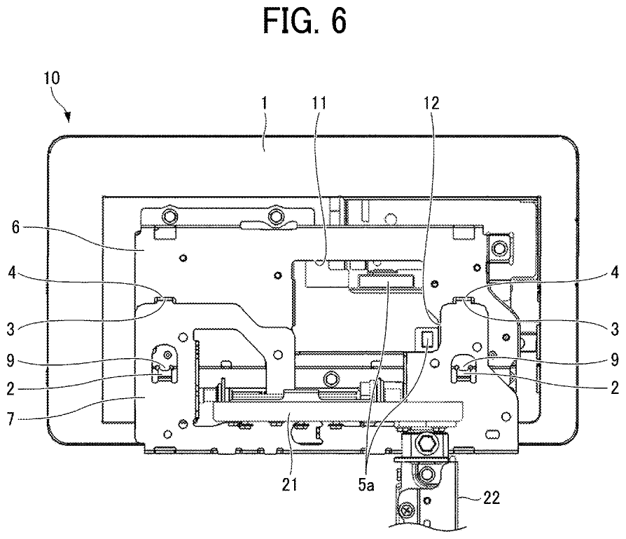

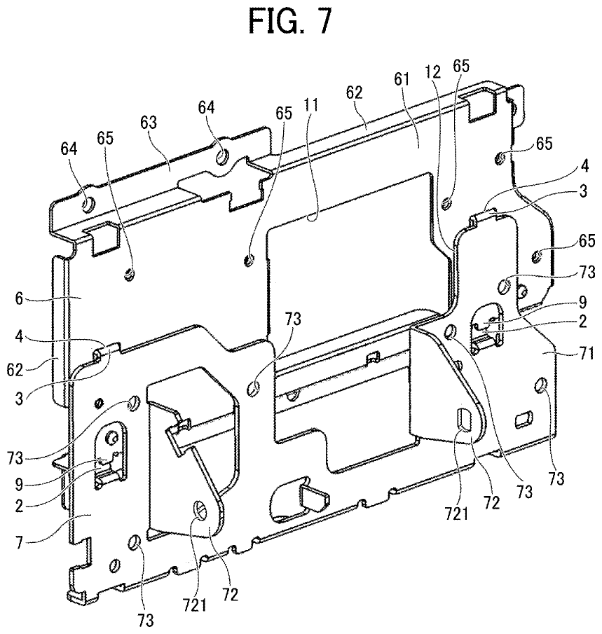

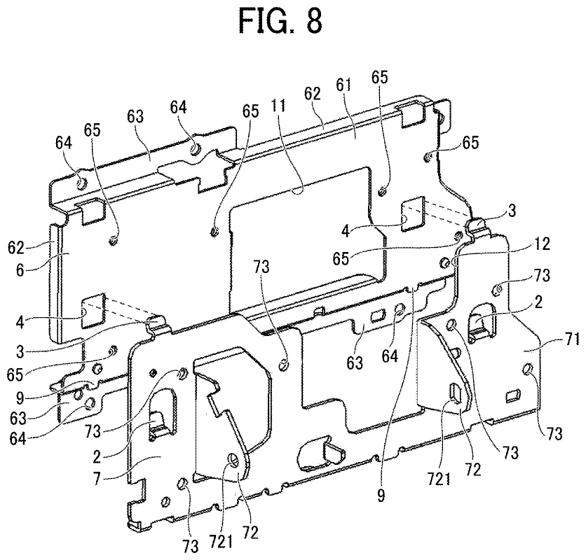

FIG. 6 is a rear view illustrating the fixed state of the operation device 10 at the second position. FIG. 7 is a perspective view illustrating the fixed state of the first fixing member 6 and the second fixing member 7 at the second position. FIG. 8 is a configuration diagram illustrating the fixed state of the first fixing member 6 and the second fixing member 7 at the second position.

When the first fixing member 6 is fixed at the second position, as illustrated in FIGS. 6 to 8, the data-transmission-unit connecting portion 5a exposed from the first opening 11 of the first fixing member 6 is entirely exposed from the first opening 11 and the second opening 12. Specifically, the edge of the second opening 12 is located outside the edge of the first opening 11, and the first opening 11 is not covered with the flat plate portion 71 of the second fixing member 7.

While the data-transmission-unit connecting portion 5a is entirely exposed from the first opening 11 and the second opening 12 when the first fixing member 6 is fixed at the second position in the present embodiment, this does not imply any limitation. The data-transmission-unit connecting portion 5a may be entirely exposed from the first opening 11 and the second opening 12 when the first fixing member 6 is fixed at the first position.

Specifically, when the first fixing member 6 is fixed at one of the first position and the second position, the first opening 11 and a portion of the second fixing member 7 may overlap each other, and the data-transmission-unit connecting portion 5a may be partially or entirely covered with the portion of the second fixing member 7. When the first fixing member 6 is fixed at another one of the first position and the second position, the data-transmission-unit connecting portion 5a may be entirely exposed from the first opening 11 and the second opening 12. In other words, when the first fixing member 6 is fixed at the first position or the second position, the second fixing member 7 partially or entirely exposes the data-transmission-unit connecting portion 5a. However, when the first fixing member 6 is fixed at the first position and the second position, the second fixing member 7 may partially or entirely expose the data-transmission-unit connecting portion 5a.

With the first fixing member 6 fixed to the second fixing member 7 at the second position as illustrated in FIG. 7, contact surfaces of the first fixing member 6 and the second fixing member 7 may be smooth surfaces.

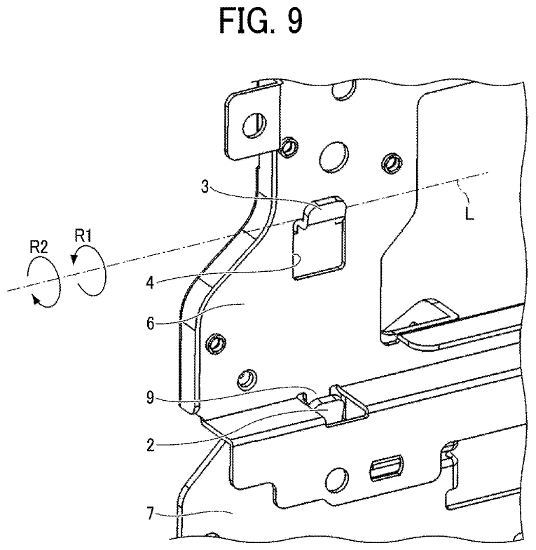

FIG. 9 is a partially enlarged view of the vicinity of an auxiliary protrusion 9 and a second protrusion 3 in FIG. 7. Specifically, FIG. 9 is a view of the vicinity of the auxiliary protrusion 9 and the second protrusion 3 located in the right area of FIG. 7 as viewed from the front surface side of the first fixing member 6.

The first fixing member 6 may have the auxiliary protrusion 9 at a lower end portion of the flat plate portion 61. When the height of the second protrusion 3 from the lower end of the second fixing member 7 is larger than the height of the first protrusion 2 from the lower end of the second fixing member 7, and when the second protrusion 3 and the engagement hole 4 engage with each other and the first fixing member 6 is fixed at the second position, the auxiliary protrusion 9 may be locked to the first protrusion 2 as illustrated in FIG. 9.

With this configuration, when an external force is applied in a direction R1 in which the upper end of the first fixing member 6 moves away from the second fixing member 7 about a straight line L including the contact portion between the second protrusion 3 and the engagement hole 4, the auxiliary protrusion 9 comes into contact with the first protrusion 2, and the rotation of the first fixing member 6 in the direction R1 is restricted. When an external force is applied in a direction R2 in which the upper end of the first fixing member 6 moves toward the second fixing member 7, the second protrusion 3 comes into contact with the front surface of the first fixing member 6, and the rotation of the first fixing member 6 in the direction R2 is restricted.

### Modification

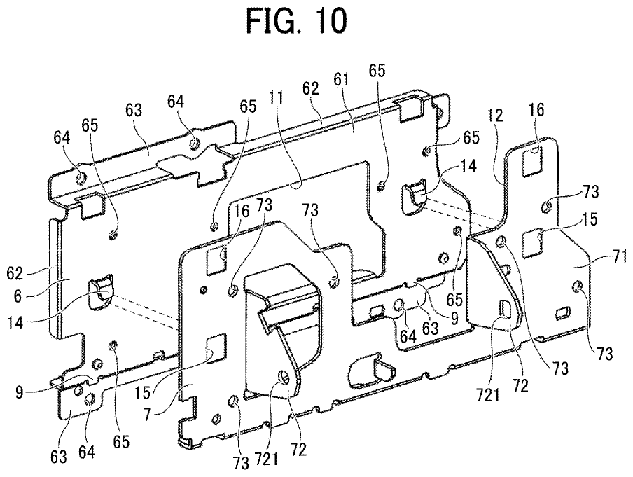

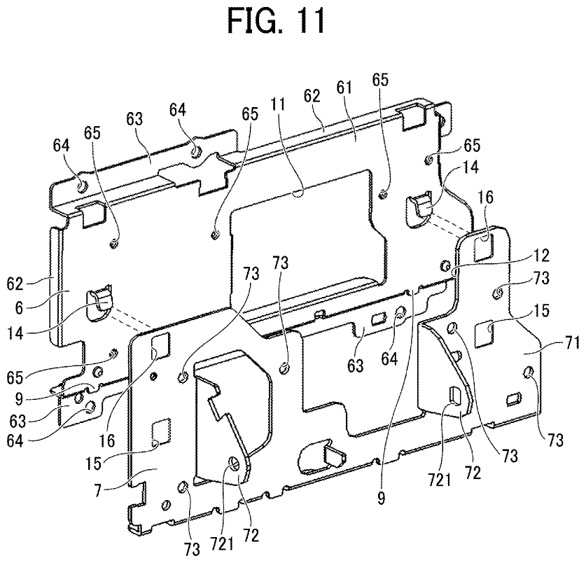

FIG. 10 is a configuration diagram illustrating another example of the fixed state of the first fixing member 6 and the second fixing member 7 at the first position. FIG. 11 is a configuration diagram illustrating the other example of the fixed state of the first fixing member 6 and the second fixing member 7 at the second position.

The example illustrated in FIGS. 10 and 11 is different from the example illustrated in FIGS. 2 to 9 in the structures of the first fixing member 6 and the second fixing member 7. Specifically, the example illustrated in FIGS. 10 and 11 is different from the example illustrated in FIGS. 2 to 9 in that the first fixing member 6 has a protrusion 14 instead of the engagement hole 4, and the second fixing member 7 has a first engagement hole 15 and a second engagement hole 16 instead of the first protrusion 2 and the second protrusion 3. With the exception of this point, the example illustrated in FIGS. 10 and 11 is similar to the example illustrated in FIGS. 2 to 9, and thus descriptions of common configurations may be omitted.

The first fixing member 6 has the protrusion 14. Specifically, the protrusion 14 is located at the flat plate portion 61. The first engagement hole 15 or the second engagement hole 16, which will be described later, of the second fixing member 7 is engageable with the protrusion 14.

The protrusion 14 may include two protrusions 14. The two protrusions 14 may be located in line symmetry with respect to a vertical line including the center of gravity of the operation panel 1. The two protrusions 14 may have the same height from the lower end of the operation panel 1. The protrusion 14 may include two or more protrusions 14.

The protrusion 14 may have a hook shape protruding toward the second fixing member 7 and having a tip portion extending downward.

The second fixing member 7 has the first engagement hole 15 engageable with the protrusion 14 and the second engagement hole 16 engageable with the protrusion 14. Specifically, the first engagement hole 15 and the second engagement hole 16 extend through the flat plate portion 71. The second fixing member 7 fixes the first fixing member 6 at the first position when the first engagement hole 15 engages with the protrusion 14. The second fixing member 7 fixes the first fixing member 6 at the second position when the second engagement hole 16 engages with the protrusion 14.

The first engagement hole 15 may include two first engagement holes 15. The second engagement hole 16 may include two second engagement holes 16. The two first engagement holes 15 may have the same height from the lower end of the second fixing member 7. The two second engagement holes 16 may have the same height from the lower end of the second fixing member 7, and the height of the two second engagement holes 16 may be different from the height of the two first engagement holes 15. In the example illustrated in FIGS. 10 and 11, the height of the second engagement holes 16 from the lower end of the second fixing member 7 is larger than the height of the first engagement holes 15 from the lower end of the second fixing member 7.

The two first engagement holes 15 may be located in line symmetry with respect to a vertical line including the center of gravity of the operation panel 1. The two second engagement holes 16 may be located in line symmetry with respect to the vertical line including the center of gravity of the operation panel 1. The first engagement hole 15 may include two or more first engagement holes 15. The second engagement hole 16 may include two or more second engagement holes 16.

The protrusion 14 and the first engagement hole 15 or the second engagement hole 16 engage with each other when the first fixing member 6 is moved from the upper end side toward the lower end side of the second fixing member 7 with the rear surface of the first fixing member 6 facing the front surface of the second fixing member 7 as illustrated in FIGS. 10 and 11. Specifically, the user can fix the operation panel 1 to the second fixing member 7 when the user holds both ends of the operation panel 1 and moves the first fixing member 6 from the upper end side toward the lower end side of the second fixing member 7 with the rear surface of the first fixing member 6 facing the front surface of the second fixing member 7.

When the first fixing member 6 is fixed at the first position, as in the state illustrated in FIG. 3, the data-transmission-unit connecting portion 5a exposed from the first opening 11 of the first fixing member 6 is partially or entirely covered with the flat plate portion 71 of the second fixing member 7.

When the first fixing member 6 is fixed at the second position, as in the state illustrated in FIG. 6, the data-transmission-unit connecting portion 5a exposed from the first opening 11 of the first fixing member 6 is entirely exposed from the first opening 11 and the second opening 12. The edge of the second opening 12 is located outside the edge of the first opening 11, and the first opening 11 is not covered with the flat plate portion 71 of the second fixing member 7.

While the data-transmission-unit connecting portion 5a is entirely exposed from the first opening 11 and the second opening 12 when the first fixing member 6 is fixed at the second position in the example illustrated in FIGS. 10 and 11, this does not imply any limitation. The data-transmission-unit connecting portion 5a may be entirely exposed from the first opening 11 and the second opening 12 when the first fixing member 6 is fixed at the first position.

As described above, an operation device 10 includes an operation panel 1 including a data-transmission-unit connecting portion 5a, a first fixing member 6, and a second fixing member 7. The first fixing member 6 has an engagement hole 4 and a first opening 11. The second fixing member 7 has a first protrusion 2 and a second protrusion 3. The first fixing member 6 is fixed at a first position when the first protrusion 2 and the engagement hole 4 engage with each other. The first fixing member 6 is fixed at a second position when the second protrusion 3 and the engagement hole 4 engage with each other.

With this configuration, the operation device 10 can change the positional relationship between the first fixing member 6 and the second fixing member 7 between the first position and the second position. Thus, when the data transmission unit is connected to the operation panel 1, the first fixing member 6 is fixed at the first position or the first fixing member 6 is fixed at the second position so that the data-transmission-unit connecting portion 5a exposed from the first opening 11 is not covered with the second fixing member 7.

Even when the position of the data-transmission-unit connecting portion 5a varies depending on the model of the operation panel 1, the positional relationship between the first fixing member 6 and the second fixing member 7 can be changed in accordance with the position of the data-transmission-unit connecting portion 5a so that the data-transmission-unit connecting portion 5a is not covered with the second fixing member 7. Thus, the operation device 10 can increase the workability of the work of connecting the data transmission unit.

An operation device 10 includes an operation panel 1 including a data-transmission-unit connecting portion 5a, a first fixing member 6, and a second fixing member 7. The first fixing member 6 has an engagement hole 4 and a first opening 11. The second fixing member 7 has a first protrusion 2 and a second protrusion 3. The first fixing member 6 has a protrusion 14. The second fixing member 7 has a first engagement hole 15 and a second engagement hole 16. The first fixing member 6 is fixed at a first position when the first engagement hole 15 and the protrusion 14 engage with each other. The first fixing member 6 is fixed at a second position when the second engagement hole 16 and the protrusion 14 engage with each other.

With this configuration, the operation device 10 can change the positional relationship between the first fixing member 6 and the second fixing member 7 between the first position and the second position. Thus, the operation device 10 can change the positional relationship between the first fixing member 6 and the second fixing member 7 so that the data-transmission-unit connecting portion 5a is not covered with the second fixing member 7, and increase the workability of the work of connecting the data transmission unit.

The engagement hole 4 includes two engagement holes 4. The first protrusion 2 includes two first protrusions 2. The second protrusion 3 includes two second protrusions 3.

With this configuration, the first fixing member 6 can be stably fixed to the second fixing member 7. In other words, the operation panel 1 can be stably fixed to the second fixing member 7. Thus, the operation device 10 can prevent the position of the operation panel 1 from deviating or prevent the operation panel 1 from being detached from the second fixing member 7 during the work of connecting the data transmission unit.

The protrusion 14 includes two protrusions 14. The first engagement hole 15 includes two first engagement holes 15. The second engagement hole 16 includes two second engagement holes 16.

With this configuration, the first fixing member 6 can be stably fixed to the second fixing member 7. In other words, the operation panel 1 can be stably fixed to the second fixing member 7. Thus, the operation device 10 can prevent the position of the operation panel 1 from deviating or prevent the operation panel 1 from being detached from the second fixing member 7 during the work of connecting the data transmission unit.

The two first protrusions 2 have the same height from a lower end of the second fixing member 7. The two second protrusions 3 have the same height from the lower end of the second fixing member 7, and the height of the two second protrusions 3 is different from the height of the two first protrusions 2.

With this configuration, the first fixing member 6 can be further stably fixed to the second fixing member 7. In other words, the operation panel 1 can be further stably fixed to the second fixing member 7. Moreover, the operation device 10 can change the height at which the first fixing member 6 is fixed with respect to the lower end of the second fixing member 7 between the first position and the second position.

The two protrusions 14 have the same height from a lower end of the operation panel 1.

With this configuration, the first fixing member 6 can be further stably fixed to the second fixing member 7. In other words, the operation panel 1 can be further stably fixed to the second fixing member 7.

The two first protrusions 2 may be located in line symmetry with respect to a vertical line including the center of gravity of the operation panel 1. The two second protrusions 3 may be located in line symmetry with respect to the vertical line including the center of gravity of the operation panel 1.

With this configuration, the first fixing member 6 can be further stably fixed to the second fixing member 7. In other words, the operation panel 1 can be further stably fixed to the second fixing member 7.

The two protrusions 14 are located in line symmetry with respect to a vertical line including the center of gravity of the operation panel 1.

With this configuration, the first fixing member 6 can be further stably fixed to the second fixing member 7. In other words, the operation panel 1 can be further stably fixed to the second fixing member 7.

The second fixing member 7 has a second opening 12. When the first fixing member 6 is fixed at one of the first position and the second position, the first opening 11 and a portion of the second fixing member 7 overlap each other, and the data-transmission-unit connecting portion 5a is partially or entirely covered with the portion of the second fixing member 7. When the first fixing member 6 is fixed at another one of the first position and the second position, the data-transmission-unit connecting portion 5a is entirely exposed from the first opening 11 and the second opening 12.

With this configuration, when the first fixing member 6 is fixed at the other one of the first position and the second position, the data-transmission-unit connecting portion 5a is entirely exposed from the first opening 11 and the second opening 12. When the user connects the data transmission unit, the user can easily access the data-transmission-unit connecting portion 5a via the first opening 11 and the second opening 12. Thus, the operation device 10 can increase the workability of the work of connecting the data transmission unit.

The operation device 10 further includes a fastening member 8 to fasten the first fixing member 6 and the second fixing member 7 to each other in a state where the first fixing member 6 is fixed to the second fixing member 7 at the first position or in a state where the first fixing member 6 is fixed to the second fixing member 7 at the second position.

With this configuration, the first fixing member 6 can be firmly fixed to the second fixing member 7. In other words, the operation panel 1 can be firmly fixed to the second fixing member 7.

A contact area between the first fixing member 6 and the second fixing member 7 in the state where the first fixing member 6 is fixed at the first position and a contact area between the first fixing member 6 and the second fixing member 7 in the state where the first fixing member 6 is fixed at the second position are larger than a contact area between the first fixing member 6 and the second fixing member 7 at a position other than the positions in the states.

With this configuration, the first fixing member 6 and the second fixing member 7 come into close contact with each other, and the first fixing member 6 and the second fixing member 7 can be firmly fixed to each other when the first fixing member 6 is fixed to the second fixing member 7.

In the state where the first fixing member 6 is fixed to the second fixing member 7 at the first position and the state where the first fixing member 6 is fixed to the second fixing member 7 at the second position, the first fixing member 6 and the second fixing member 7 have smooth contact surfaces.

With this configuration, when the first fixing member 6 is fixed to the second fixing member 7, the first fixing member 6 and the second fixing member 7 can be firmly fixed to each other.

The first protrusion 2 and the second protrusion 3 each have a hook shape protruding toward the first fixing member 6 and having a tip portion extending upward. The first protrusion 2 or the second protrusion 3 and the engagement hole 4 engage with each other when the first fixing member 6 is moved from an upper end side toward a lower end side of the second fixing member 7 with the rear surface of the first fixing member 6 facing a front surface of the second fixing member 7.

With this configuration, the user can fix the operation panel 1 to the second fixing member 7 when the user holds both ends of the operation panel 1 and moves the first fixing member 6 from the upper end side toward the lower end side of the second fixing member 7 with the rear surface of the first fixing member 6 facing the front surface of the second fixing member 7. Thus, the operation device 10 can easily fix the operation panel 1 to the second fixing member 7.

The protrusion 14 has a hook shape protruding toward the second fixing member 7 and having a tip portion extending downward. The protrusion 14 and the first engagement hole 15 or the second engagement hole 16 engage with each other when the first fixing member 6 is moved from an upper end side toward a lower end side of the second fixing member 7 with the rear surface of the first fixing member 6 facing a front surface of the second fixing member 7.

With this configuration, the user can fix the operation panel 1 to the second fixing member 7 when the user holds both ends of the operation panel 1 and moves the first fixing member 6 from the upper end side toward the lower end side of the second fixing member 7 with the rear surface of the first fixing member 6 facing the front surface of the second fixing member 7. Thus, the operation device 10 can easily fix the operation panel 1 to the second fixing member 7.

The first fixing member 6 has a flat plate portion 61 and an auxiliary protrusion 9. The engagement hole 4 extends through the flat plate portion 61. The second protrusion 3 has a height from a lower end of the second fixing member 7, the first protrusion 2 has a height from the lower end of the second fixing member 7, and the height of the second protrusion 3 is larger than the height of the first protrusion 2. The auxiliary protrusion 9 is locked to the first protrusion 2 when the second protrusion 3 and the engagement hole 4 engage with each other and the first fixing member 6 is fixed at the second position.

With this configuration, when an external force is applied in a direction in which the first fixing member 6 rotates about a straight line L including the contact portion between the second protrusion 3 and the engagement hole 4, and when the auxiliary protrusion 9 comes into contact with the first protrusion 2, the rotation of the first fixing member 6 in a direction R1 is restricted. When the second protrusion 3 comes into contact with the front surface of the first fixing member 6, the rotation of the first fixing member 6 in a direction R2 is restricted. Thus, the operation device 10 can fix the operation panel 1 to the second fixing member 7 while restricting the rotation of the operation panel 1.

The operation device 10 further includes a rotation shaft 23 to rotatably support the first fixing member 6 or the second fixing member 7.

With this configuration, the angle of the operation panel 1 can be freely changed, and the user can operate the operation panel 1 at a desired angle.

An image forming apparatus 100 includes the operation device 10. With this configuration, the operation device 10 can change the positional relationship between the first fixing member 6 and the second fixing member 7 so that the data-transmission-unit connecting portion 5a is not covered with the second fixing member 7. Thus, the image forming apparatus 100 can increase the workability of the work of connecting the data transmission unit.

Aspects of the present disclosure are, for example, as follows.

### Aspect 1

According to Aspect 1, an operation device provided for an apparatus body of an apparatus includes an operation panel including a data-transmission-unit connecting portion at a rear surface of the operation panel, the data-transmission-unit connecting portion to which a data transmission unit connected from the apparatus body is connected; a first fixing member located on the rear surface of the operation panel and having a first opening from which the data-transmission-unit connecting portion is exposed; and a second fixing member fixable at a first position and a second position with respect to a rear surface of the first fixing member. The second fixing member exposes the data-transmission-unit connecting portion at the first position or the second position.

### Aspect 2

According to Aspect 2, in the operation device of Aspect 1, the first fixing member has an engagement hole. The second fixing member has a first protrusion engageable with the engagement hole and a second protrusion engageable with the engagement hole, the first fixing member is fixed at the first position in a case where the first protrusion and the engagement hole engage with each other, and the first fixing member is fixed at the second position in a case where the second protrusion and the engagement hole engage with each other.

### Aspect 3

According to Aspect 3, in the operation device of Aspect 1, the first fixing member has a protrusion. The second fixing member has a first engagement hole engageable with the protrusion and a second engagement hole engageable with the protrusion, the first fixing member is fixed at the first position in a case where the first engagement hole and the protrusion engage with each other, and the first fixing member is fixed at the second position in a case where the second engagement hole and the protrusion engage with each other.

### Aspect 4

According to Aspect 4, in the operation device of Aspect 2, the engagement hole includes two engagement holes, the first protrusion includes two first protrusions, and the second protrusion includes two second protrusions.

### Aspect 5

According to Aspect 5, in the operation device of Aspect 3, the protrusion includes two protrusions, the first engagement hole includes two first engagement holes, and the second engagement hole includes two second engagement holes.

### Aspect 6

According to Aspect 6, in the operation device of Aspect 4, the two first protrusions have the same height from a lower end of the second fixing member. The two second protrusions have the same height from the lower end of the second fixing member, and the height of the two second protrusions is different from the height of the two first protrusions.

### Aspect 7

According to Aspect 7, in the operation device of Aspect 5, the two protrusions have the same height from a lower end of the operation panel.

### Aspect 8

According to Aspect 8, in the operation device of Aspect 4 or Aspect 6, the two first protrusions are located at a right portion and a left portion of the operation panel with respect to the center of gravity of the operation panel. The two second protrusions are located at the right portion and the left portion of the operation panel with respect to the center of gravity of the operation panel.

### Aspect 9

According to Aspect 9, in the operation device of Aspect 5 or Aspect 7, the two protrusions are located in line symmetry with respect to a vertical line including the center of gravity of the operation panel.

### Aspect 10

According to Aspect 10, in the operation device of any one of Aspect 1 to Aspect 9, the second fixing member has a second opening. In a case where the first fixing member is fixed at one of the first position and the second position, the first opening and a portion of the second fixing member overlap each other, and the data-transmission-unit connecting portion is partially or entirely covered with the portion of the second fixing member. In a case where the first fixing member is fixed at another one of the first position and the second position, the data-transmission-unit connecting portion is entirely exposed from the first opening and the second opening.

### Aspect 11

According to Aspect 11, the operation device of any one of Aspect 1 to Aspect 10 further includes a fastening member to fasten the first fixing member and the second fixing member to each other in a state where the first fixing member is fixed to the second fixing member at the first position or in a state where the first fixing member is fixed to the second fixing member at the second position.

### Aspect 12

According to Aspect 12, in the operation device of Aspect 11, a contact area between the first fixing member and the second fixing member in one of the state where the first fixing member is fixed at the first position and the state where the first fixing member is fixed at the second position is larger than a contact area between the first fixing member and the second fixing member in another one of the state where the first fixing member is fixed at the first position and the state where the first fixing member is fixed at the second position.

### Aspect 13

According to Aspect 13, in the operation device of Aspect 11 or Aspect 12, in each of the state where the first fixing member is fixed at the first position and the state where the first fixing member is fixed at the second position, the first fixing member and the second fixing member have smooth contact surfaces.

### Aspect 14

According to Aspect 14, in the operation device of any one of Aspect 2, Aspect 4, Aspect 6, and Aspect 8, the first protrusion and the second protrusion each have a hook shape protruding toward the first fixing member and having a tip portion extending upward. The first protrusion or the second protrusion and the engagement hole engage with each other in a case where the first fixing member is moved from an upper end side toward a lower end side of the second fixing member with the rear surface of the first fixing member facing a front surface of the second fixing member.

### Aspect 15

According to Aspect 15, in the operation device of any one of Aspect 3, Aspect 5, Aspect 7, and Aspect 9, the protrusion has a hook shape protruding toward the second fixing member and having a tip portion extending downward. The protrusion and the first engagement hole or the second engagement hole engage with each other in a case where the first fixing member is moved from an upper end side toward a lower end side of the second fixing member with the rear surface of the first fixing member facing a front surface of the second fixing member.

### Aspect 16

According to Aspect 16, in the operation device of any one of Aspect 2, Aspect 4, Aspect 6, and Aspect 8, the first fixing member has a flat plate portion and an auxiliary protrusion at a lower end portion of the flat plate portion. The engagement hole extends through the flat plate portion. The second protrusion has a height from a lower end of the second fixing member, the first protrusion has a height from the lower end of the second fixing member, and the height of the second protrusion is larger than the height of the first protrusion. The auxiliary protrusion is locked to the first protrusion in a case where the second protrusion and the engagement hole engage with each other and the first fixing member is fixed at the second position.

### Aspect 17

According to Aspect 17, the operation device of any one of Aspect 1 to Aspect 16, further includes a rotation shaft to rotatably support the first fixing member or the second fixing member.

### Aspect 18

According to Aspect 18, an image forming apparatus includes the operation device of any one of Aspect 1 to Aspect 17.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An operation device provided for an apparatus body of an apparatus, comprising:
an operation panel including a data-transmission-unit connecting portion at a rear surface of the operation panel, the data-transmission-unit connecting portion to which a data transmission unit connected from the apparatus body is connected;
a first fixing member located on the rear surface of the operation panel and having a first opening from which the data-transmission-unit connecting portion is exposed; and
a second fixing member fixable at a first position and a second position with respect to a rear surface of the first fixing member, the second fixing member exposing the data-transmission-unit connecting portion at the first position or the second position.

2. The operation device according to claim 1,
wherein the first fixing member has an engagement hole, and
wherein the second fixing member has a first protrusion engageable with the engagement hole and a second protrusion engageable with the engagement hole,
the first fixing member is fixed at the first position in a case where the first protrusion and the engagement hole engage with each other, and
the first fixing member is fixed at the second position in a case where the second protrusion and the engagement hole engage with each other.

3. The operation device according to claim 1,
wherein the first fixing member has a protrusion, and
wherein the second fixing member has a first engagement hole engageable with the protrusion and a second engagement hole engageable with the protrusion,
the first fixing member is fixed at the first position in a case where the first engagement hole and the protrusion engage with each other, and
the first fixing member is fixed at the second position in a case where the second engagement hole and the protrusion engage with each other.

4. The operation device according to claim 2, wherein the engagement hole includes two engagement holes, the first protrusion includes two first protrusions, and the second protrusion includes two second protrusions.

5. The operation device according to claim 3, wherein the protrusion includes two protrusions, the first engagement hole includes two first engagement holes, and the second engagement hole includes two second engagement holes.

6. The operation device according to claim 4,
wherein the two first protrusions have the same height from a lower end of the second fixing member, and
wherein the two second protrusions have the same height from the lower end of the second fixing member, and the height of the two second protrusions is different from the height of the two first protrusions.

7. The operation device according to claim 5, wherein the two protrusions have the same height from a lower end of the operation panel.

8. The operation device according to claim 4,
wherein the two first protrusions are located at a right portion and a left portion of the operation panel with respect to the center of gravity of the operation panel, and
wherein the two second protrusions are located at the right portion and the left portion of the operation panel with respect to the center of gravity of the operation panel.

9. The operation device according to claim 5, wherein the two protrusions are located in line symmetry with respect to a vertical line including the center of gravity of the operation panel.

10. The operation device according to claim 1,
wherein the second fixing member has a second opening,
wherein, in a case where the first fixing member is fixed at one of the first position and the second position, the first opening and a portion of the second fixing member overlap each other, and the data-transmission-unit connecting portion is partially or entirely covered with the portion of the second fixing member, and
wherein, in a case where the first fixing member is fixed at another one of the first position and the second position, the data-transmission-unit connecting portion is entirely exposed from the first opening and the second opening.

11. The operation device according to claim 1, further comprising a fastening member to fasten the first fixing member and the second fixing member to each other with the first fixing member fixed to the second fixing member,
wherein the first fixing member and the second fixing member are fixed to each other at one of the first position and the second position.

12. The operation device according to claim 11, wherein a contact area between the first fixing member and the second fixing member fixed at one of the first position and the second position is larger than a contact area between the first fixing member and the second fixing member held at another one of the first position and the second position.

13. The operation device according to claim 11, wherein the first fixing member and the second fixing member have smooth contact surfaces.

14. The operation device according to claim 2,
wherein the first protrusion and the second protrusion each have a hook shape protruding toward the first fixing member and having a tip portion extending upward, and
wherein the first protrusion or the second protrusion and the engagement hole engage with each other in a case where the first fixing member is moved from an upper end side toward a lower end side of the second fixing member with the rear surface of the first fixing member facing a front surface of the second fixing member.

15. The operation device according to claim 3,
wherein the protrusion has a hook shape protruding toward the second fixing member and having a tip portion extending downward, and
wherein the protrusion and the first engagement hole or the second engagement hole engage with each other in a case where the first fixing member is moved from an upper end side toward a lower end side of the second fixing member with the rear surface of the first fixing member facing a front surface of the second fixing member.

16. The operation device according to claim 2,
wherein the first fixing member has a flat plate portion and an auxiliary protrusion at a lower end portion of the flat plate portion,
wherein the engagement hole extends through the flat plate portion,
wherein the second protrusion has a height from a lower end of the second fixing member, the first protrusion has a height from the lower end of the second fixing member, and the height of the second protrusion is larger than the height of the first protrusion, and
wherein the auxiliary protrusion is locked to the first protrusion in a case where the second protrusion and the engagement hole engage with each other and the first fixing member is fixed at the second position.

17. The operation device according to claim 1, further comprising a rotation shaft to rotatably support the first fixing member or the second fixing member.

18. An image forming apparatus comprising:
the operation device according to claim 1; and
the apparatus body including an image forming device.
